(19) United States
(12) Patent Application Publication
(10) Pub. No.: US 2007/0016829 A1
(43) Pub. Date: Jan. 18, 2007

(54) Test case generator

(75) Inventors: Karthikeyan Subramanian, Redmond, WA (US); Murtaza H. Hakim, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/181,270

(22) Filed: Jul. 14, 2005

(51) Int. Cl. G06F 11/00

(52) U.S. Cl. 714/38

(57) ABSTRACT

A test system for software includes a test case generator, which produces test cases, and a test framework, which executes the test cases. The test case generator represents test cases as actions to be performed. Actions for inclusion in a test case are selected by a rule-based inference engine applying user specified rules based on a test scenario. The test scenario may be determined in part based on user input and in part based on the current state of the software under test. Code to perform the actions is separately provided as a set of action handlers. The test framework maps the actions specified as part of the test case to action handlers and supplies parameters to the action handlers. The test system simplifies the development and maintenance of test cases and allows more through testing of software.

### BACKGROUND OF INVENTION

Software is frequently tested during its development. A typical test process involves the creation of multiple test cases. Typically, each test case is prepared by a human test engineer to interact with a component of the software under test and to exercise some aspect of that component. To perform a test, one or more test cases is selected for application to the software under test, with the selection based on the aspects of the software under test to be tested.

Execution of a test is automated through the use of a test framework. The test framework applies the selected test cases to the software under test and observes the response from the software under test to determine whether the software under test responded as expected. A test framework also performs other test management functions, such as logging test results or reporting to a user.

The test management functions performed by the test framework are frequently implemented by elements in a library associated with the test framework. As the test cases are developed, these library elements are linked with the code implementing the test case and executable code is formed that incorporates code to execute the test case and the test framework functions. This executable code is run to apply the test case to the software under test.

It would be desirable to improve the process for testing software.

### SUMMARY OF INVENTION

The invention relates to the generation of test cases for testing software. A test case generator produces a representation of a test case describing actions that are to be performed during execution of the test case. Actions represented in the test case can be performed by action handlers as the test case is executed by a test framework. Generating test cases in this manner simplifies test development and maintenance and can allow for more extensive or more focused testing of software.

In one aspect, the representation of the test case may be produced by a rule-based component that selects actions to include in the representation of the test case based on application of rules to a specified test scenario. The test scenario may be specified by a user and/or based on the state of a component under test. Separately providing action handlers that can perform test actions and rules that define when those actions are taken promotes reuse of action handlers in multiple test cases, reducing the overall effort needed to develop multiple test cases. Using state information about the component under test to specify the test scenario allows for more thorough testing.

In another aspect, representing a test case based on actions simplifies testing of test components that may be invoked through any one of multiple interfaces. The representation of the test case may indicate actions independent of the interface through which those actions will be invoked as a test case executes. During test execution, action handlers may be selected to perform actions in the test case based on the interface through which the component under test is accessed.

In a further aspect, the action handlers interact with the test framework through an interface. By establishing an interface, action handlers may be developed independently of the test framework, allowing action handlers to be leveraged across multiple test environments. Also, test cases do not need to be re-written or recreated if an aspect of the test framework changes.

The foregoing summary is not limiting of the invention, which is defined by the appended claims.

### BRIEF DESCRIPTION OF DRAWINGS

The accompanying drawings are not intended to be drawn to scale. In the drawings, each identical or nearly identical component that is illustrated in various FIGS. is represented by a like numeral. For purposes of clarity, not every component may be labeled in every drawing. In the drawings:

FIG. 1 is a sketch illustrating the software architecture of an embodiment of a test generator;

FIG. 2 is a sketch illustrating the software architecture of an embodiment of a test framework;

FIG. 3 is a sketch illustrating the format of an embodiment of an instruction file;

FIG. 4 is a sketch illustrating the structure of an embodiment of an interface to action handlers;

FIG. 5 is a sketch illustrating the structure of an embodiment of a mapper file;

FIG. 6 is a flow chart illustrating an embodiment of a process of creating an instruction file; and

FIG. 7 is flow chart of an embodiment of a process for executing a test cast based on an instruction file.

### DETAILED DESCRIPTION

We have recognized that testing of software can be improved with a test case generator that generates test cases in a format that enables simplifications in the overall testing process. Improvements may also be obtained with a test framework that executes test cases by accessing action handlers through established interfaces.

In one embodiment, the test system is modular, as are the test cases developed for the test system, which simplifies creation and execution of test cases and facilitates maintenance of tests. The test system uses a test case generator separate from a test framework in which one or more test cases are executed as part of a test. In addition, the test case generator may produce a representation of a test case that separates components that perform test actions from logic used to determine which actions are to be performed.

The logic of a test case may be reflected in an instruction file that defines actions to be performed when a test case is executed. The components that perform actions are termed “action handlers,” and may be developed separately from the instruction file. Having separate action handlers simplifies test development and maintenance and can allow for more extensive or more focused testing of components of the software under test. For example, the same action handlers can be used with different instruction files to provide multiple test cases. Conversely, an instruction file containing test logic may be reused with different action handlers. For example, a component of the software under test may be accessible from multiple interfaces. The test logic for testing that component may be the same regardless of the interface through which the component is accessed, but different action handlers may be used to exercise the component under test through different interfaces. To facilitate use of different action handlers with the same instruction file, the test framework may be separately provided with information mapping the actions to be performed to action handlers that are to perform those actions.

In some embodiments, the logic used to determine which actions are performed as part of a test case is represented as a set of rules that are used by a rule-based test case generator. As part of preparing tests, a test engineer may specify a set of rules for each component of the software under test. The rules may define actions to include in the representation of test cases based on specified test scenarios.

A test scenario may be specified in any of multiple ways, such as by a user and/or based on the state of a component under test. Using current state information concerning the component under test to define test actions allows more focused and more accurate testing. In some embodiments, use of state information is facilitated because the system may dynamically generate test cases as a test is being executed. Dynamic generation of test cases is enabled by specifying test cases in terms of actions that can be performed by action handlers that exist separate from the test framework. Because the action handlers do not need to be linked with the test framework to form executable code representing the test case, the test case can be dynamically specified.

In some embodiments, the action handlers are separated from the test framework by providing an interface through which the action handlers and the test framework may interact. The action handlers may be written in any programming language, allowing action handlers to be leveraged across multiple test environments. The development and maintenance of tests is further simplified because test cases do not need to be re-written nor does a binary for the test case need to be recreated if an aspect of the test framework changes.

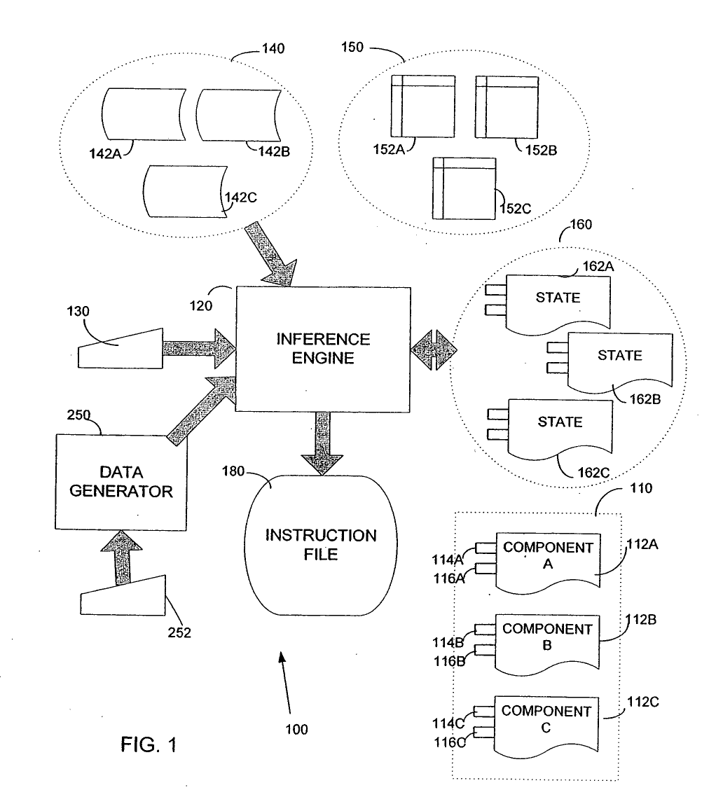

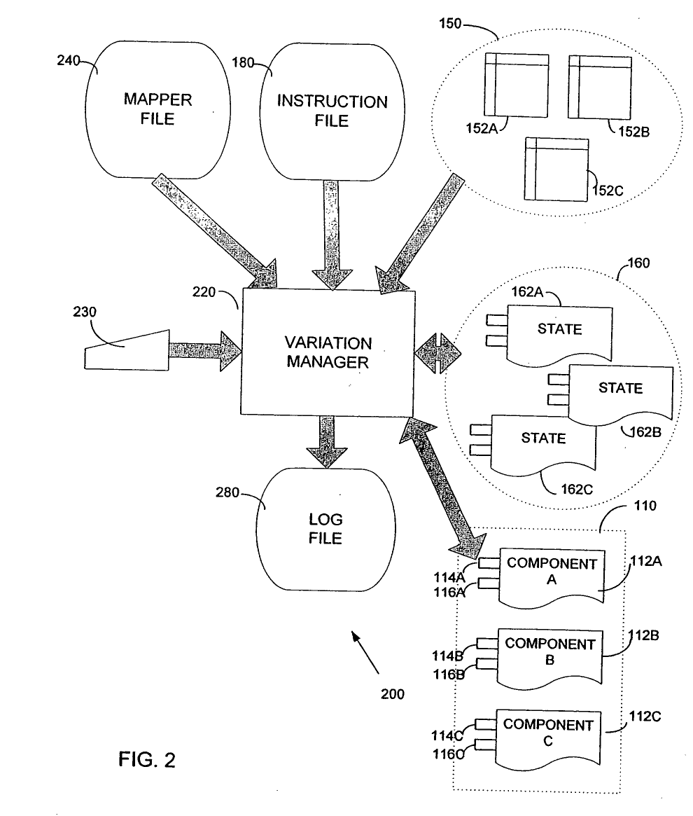

Such a test system is illustrated by the embodiment of FIG. 1, showing a test case generator, and FIG. 2, showing a test framework. Turning to FIG. 1, an embodiment of a test case generator 100 is shown. Test case generator 100 may operate in any suitable environment. For example, it may execute on a computer work station, server, or other suitable platform as is now known or hereafter developed for testing software. Test case generator 100 creates test cases that are executed by test framework 200 (FIG. 2).

In this example, test case generator 100 generates test cases to test software under test 110. Software under test 110 includes multiple components, of which components 112A, 112B and 112C are illustrated. Most programs include numerous components. Only three components are shown for simplicity, but the number of components within software under test 110 is not a limitation of the invention.

Software under test 110 may represent an application for a desktop computer, such as a word processor or a spreadsheet program. Such an application is made of multiple components, each containing multiple computer-executable instructions. The specific programming language in which software under test 110 is developed is also not a limitation on the invention.

Each of the components 112A, 112B and 112C includes multiple interfaces through which the component may be invoked when software under test 110 executes. For example, software under test 110 may be a word processing application and component 112A may be a component of that word processing application that opens a file. Such a component may be invoked in multiple ways as the word processing application operates. The component may be invoked when a user selects an “Open” command from a menu. Alternatively, the open command may be invoked in response to a user entering a combination of keystrokes or in other scenarios as the word processing application executes. To fully test software under test 110, the functionality of each component may be tested as invoked through each interface. In the described embodiment, test case generator 100 can generate test cases to exercise any of the components of software under test 110 through any of the interfaces.

To generate the required test cases, test case generator 100 includes an inference engine 120. Inference engine 120 may be a component containing computer-executable instructions written in any desired computer programming language. The test system is modular such that the implementation of test case generator 100 may be independent of the implementation of both software under test 110 and test framework 200. In one embodiment, inference engine 120 is written in the C++ programming language, but any suitable programming language may be used.

Inference engine 120 receives input defining a desired test scenario and generates a test case for that test scenario. In the embodiment illustrated, inference engine 120 receives input on a test scenario from multiple sources. In the embodiment of FIG. 1, those sources of input are user input 130 and state information 160.

User input 130 may be provided through a user interface of the computer on which test case generator 100 executes. For example, a user may provide input through a keyboard or by making selections with a mouse from a menu presented as part of a graphical user interface. User input 130 may alternatively come from a data file created directly by a user or created indirectly by the user invoking a software tool, but any suitable mechanism for providing input to define a test scenario may be employed.

The input defining a test scenario may specify characteristics that can be used to determine actions to be taken as part of a test case. The input may, for example, specify a specific component or set of components of software under test 110 to be tested. The input may additionally or alternatively specify a depth of a test. For example, a user may specify that a test case be generated including the minimum number of actions necessary to exercise each major function of a component under test. Alternatively, input specifying the depth of a test may indicate that every function of the component be exercised multiple times during a test case using different parameter values each time it is executed.

User input 130 may be in any suitable form. For example, input representing a component may be provided as a character string of the name of the component or a code assigned to the component. Alternatively, input may describe a component to be tested with a pointer to a location in memory where the instructions implementing that component are stored or a pointer to a memory structure defining the component. The input defining testing depth may be in the form of a number or other code. Other input may use character strings, numeric codes, pointers or any other suitable form to define a test scenario in whole or in part for inference engine 120.

A test scenario may also be defined in part with state information 160. In the illustrated embodiment, state information includes component state information 162A, 162B and 162C that provides state information for components 112A, 112B and 112C, respectively. State information 160 may be one or more data structures in memory or any other data source that provides data on the state of the components of software under test 110. State information may be dynamically updated by test framework 200 (FIG. 2). As tests are executed, test framework 200 may interact with each component to determine its actual state is and then provide this information to state information 160. Alternatively, state information may be totally or partially based on an emulation of the software components under test, using a model of the performance of the components to determine state based on the inputs applied and/or outputs measured from the component.

Regardless of the precise mechanism by which state information is obtained and a test scenario is defined, inference engine 120 determines actions required to exercise the software under test to implement the test scenario. In this embodiment, inference engine 120 is a rule-based inference engine. Rule based inference engines are known in the art and any suitable inference engine, whether now known or hereafter developed, may be used to implement inference engine 120.

In the illustrated embodiment, inference engine 120 operates on rules in a rule library 140. Rule library 140 includes multiple sets of rules, each set of rule corresponding to a component of software under test 110. The following is an example of a rule:

```
Sample Rule
CreateGroupRule:
    Can_apply:
        Can we crate a group?
        We can always create a group
    Apply:
        CreateGroup
    Generate_Instructions:
        Generate instructions/test case
```

Each set of rules may be specified in any suitable form. For example, a set of rules may be stored as a structured data file, such as an XML file, in which different fields are used to identify the conditions under which each rule applies or the actions to be taken to satisfy a rule. Alternatively, each rule may be specified as a series of conditional statements expressed in executable code. In the latter case, each rule may be a method associated with a component of executable code. However, any suitable way of representing rules defining actions to be taken in a test scenario, whether now known or hereafter developed, may be used.

In the illustrated embodiment, test scenario information specifying a component of software under test 110 to be tested is used to select a set of rules, such as 142A, 142B, or 142C. Other test scenario information is used to identify how the rules in the selected set are applied to determine the actions that are to be performed as part of a test case. For example, user input 130 specifying a relatively low depth of testing may result in each rule in the set being applied only once in random order. Conversely, an input specifying testing with more depth may result in combinations of the same rules being applied in different orders or with different parameters.

State information 160 may also influence the results of applying rules in the selected set. For example, when testing a component that is a portion of a file management system, state information may indicate that the file management system has no file open. Accordingly, an action directing the component under test to close a file may not be desirable in a test case. A rule in a set corresponding to that component may specify that an action commanding the component under test to close a file is included in the test case when a file is open but not when no file is open. State information 160 allows a rule in this form to be evaluated to determine actions that are part of the test case.

In the described embodiment, the components to be tested are described by a set of rules within rule library 140 and component state information in state information 160. This information may be supplied together or separately. In one embodiment, a set of rules for a component and parameters that define the state for that component may be provided together as a package or other program component in what may be called a “virtual component,” but such information may be provided in any suitable form. Such information may be supplied by a test engineer as part of test development. The test engineer may generate the information “by hand” or by using one or more tools that generate or facilitate the generation of this information.

The test engineer may also provide an action handler library 150. Each action handler within action handler library 150 defines the specific steps performed to execute an action. Each action handler may be expressed as executable code, but any suitable representation may be used.

In operation, inference engine 120 creates a test case by applying rules from rule library 140 as dictated by the test scenario information. The test case is represented as a series of actions that are performed when the test case is applied. In the described embodiment, the representation of the test case does not directly contain executable code. Rather, the test case is represented in instruction file 180 that contains a listing of desired actions. During a test, actions are performed by action handlers, such as 152A, 152B and 152C in action handler library 150. Accordingly, instruction file 180 need not include executable test code. In the described embodiment, instruction file 180 is a delimited text file that lists actions to be taken as part of a test case. As a specific example, instruction file 180 may be an XML file.

If an action will require data when performed, data may be provided by data generator 250. Data generator 250 may be a software component that provides a data value appropriate for any parameter required by an action. In one embodiment, data generator 250 may contain a store of valid parameter values and can provide a valid parameter value of any type needed to perform an action. For example, data generator 250 may contain a store of valid file names and can select one of the file names from the store to provide a file name as a parameter for any action that includes manipulating a file. Similar stores may be maintained for other types of parameters, such as strings or command names.

Data generator 250 may be constructed to provide parameters in other ways. For example, data generator 250 may be constructed using a random number generator. A random number generator may be used to randomly select or construct parameter values. As a further alternative, data generator 250 may be constructed to receive user input 252. User input may come, for example, from a test engineer creating a test case.

However, any suitable method may be used to provide parameter values. Combinations of methods of providing parameter values may also be used. For example, data generator 250 may provide a parameter value specified by a test engineer, if one was specified. If no parameter value was specified, data generator 250 may prompt the user to specify a parameter value when one is needed to invoke a test handler. If the user declines to specify a parameter value, data generator 250 may use an appropriate parameter value from its data store or may, if no appropriate value is stored, randomly generate a value. Regardless of how parameter values are selected, the values may be written to instruction file 180 in a way that associates the action with the parameter values such that parameter values are available when the action is executed.

The test case represented in instruction file 180 may then be passed to test framework 200 (FIG. 2). Test framework 200 may operate on any suitable platform. For example, it may operate on a computer as is traditionally used to perform software testing, which may be the same physical device on which test case generator 100 operates or may be another device coupled to the test environment over a network.

In the illustrated embodiment, test framework 200 includes a variation manager 220. Variation manager 220 is a software component that uses the information in instruction file 180 to select code that actually exercises software under test 110. In addition, variation manager 220 configures that code, such as by supplying parameters to it, and then causes the code to execute, thereby exercising the software under test. Variation manager 220 may capture results of the executing the tests and store them in log file 280.

Variation manager 220 performs functions analogous to functions performed in known test harnesses. Variation manager 220 may be a software component constructed using programming techniques as used in the art for constructing a test harness, whether now known or hereafter developed. In this example, variation manager 220 is a component written in the C++ programming language, but there is no requirement that variation manager 220 be written in the same programming language as test case generator 100, software under test 110 or action handlers such as 152A, 152B or 152C.

Variation manager 220 exercises code under test 110 by reading actions from instruction file 180. The actions may be read in any suitable order, but may for simplicity be read in the order written into instruction file 180. As variation manager 220 reads each action, it interacts with an action handler to perform that action.

Variation manager 220 may select an action handler to perform the desired action. In the illustrated embodiment, variation manager 220 reads mapper file 240 to determine which action handler to access to perform a desired action. Here, mapper file 240 is a delimited file that specifies, for each action in instruction file 180 an action handler to perform that action. Mapper file 240 may be supplied by a test engineer configuring the test system with action handlers. A single mapper file may be used for all test cases or a separate mapper may be provided for use in specific cases. Being able to specify a mapper file allows substantial flexibility creating test cases.

For example, in the illustrated embodiment, components under test may be invoked through one of multiple interfaces, such as interfaces 114A and 116A in component 112A. Different mapper files 240 may be used to specify different mappings such that a different action handler is used, depending on the interface through which the component under test is to be exercised. Use of mapper file 240 thus allows inference engine 120 (FIG. 1) to specify actions based on a desired test logic without producing an instruction file that is either dependent on the specific action handlers used to implement each action or the interface through which a component under test will be exercised.

Once an action handler is identified, variation manager 220 invokes the action handler. In the described embodiment, each of the action handlers includes an interface through which it may be accessed by variation manager 220 as a test is being executed. Any form of interface may be used, but preferably the interface is predefined and all action handlers in action handler library 150 include the same form of interface. In the described embodiment, the interface is independent of the specific implementation of variation manager 220. An interface prepared in accordance with a known interface standard may be used. As a specific example, a COM interface may be used such that each of the action handlers in action handler library is a COM server. However, any interface allowing interaction between variation manager 220 and action handlers may be used, such as interfaces provided by the .NET framework.

Each action handler in action handler library 150 may be coded in any language that supports the selected interface. As a specific example, each action handler may be written in the C++ language, but it is not a requirement that the action handlers be written in the same language as any other portion of the test system or that all action handlers be written in the same language.

When invoked, each action handler performs operations that exercise one or more aspects of software under test 110. Each action handler may be coded using practices as are used to prepare known tests. For example, the action handler may apply a stimulus to the software under test 110 and indicate an intended response. The stimulus may be in the form of a command to the software under test and may include one or more parameters that create different operating states of the software under test.

Each action handler may communicate an intended response to variation manager 220 through the interface between variation manager 220 and the test handler. The expected response may be specified in any suitable way, such as by indicating a parameter that should be returned by a component of the software under test when executed or an action that software under test 110 should take in response to the specified input. Actions taken by software under test 110 may include calling an operating system utility, such at those that manage data files or user interfaces. Conventional test harnesses observing responses from software under test harness 200 may be implemented to perform these functions using conventional programming techniques, whether now known or hereafter developed.

Variation manager 220 may also compare the observed response to an expected response to identify whether software under test responded as expected to the applied test case. If the observed response indicates an error by software under test, variation manager 220 may store information in log file 280 indicating that an error has occurred. Logging errors in this fashion is a function of known test harnesses and variation manager 220 may be programmed to perform this function using techniques as used in conventional test harnesses, whether now known or hereafter developed.

Alternatively, variation manager may be programmed to provide a response of software under test 110 to the action handler that was invoked to perform the action. Each action handler may be programmed to compare the observed response to an expected response to determine whether an error occurred. In such an embodiment, the action handler may store a record of the error or may provide an indication to variation manager 220 that an error has occurred for variation manager 220 to store.

As a further alternative, the failure analysis function may be distributed over the action handler and variation manager 220 or other portions of test harness 200. Variation manager, or other components of test harness 200, may observe a response from software under test 100 and compare the observed response to a desired response that should occur upon execution of an action handler. Variation manager may therefore detect operating conditions that deviate from the desired operating conditions. Rather than logging all such deviations as errors, variation manager 220 may communicate to the action handler that a deviation occurred. The action handler may then determine the appropriate action by the test system in response to a deviation. In some instances, a deviation may not be caused by an error or may be the result of a known error for which no error logging is required. By allowing an action handler to specify the response to a deviation, the test system is more flexible because a test engineer may program the action handlers to respond differently to deviations in different scenarios.

One way that variation manager 220 may communicate deviations to action handlers is through a defined interface to each action handler. As a specific example, each action handler may be prepared with an optional exception handler that is programmed to provide the desired response to deviations. Upon detecting a deviation, variation manager may raise an exception, transferring control to the exception handler in the action handler for processing. The exception handler may be programmed to respond in any desired way, such as by logging the error or ignoring the error. If the exception handler is not defined, then variation manager 220 may log the error or exception accordingly or stop the test accordingly.

Test harness 200 also supports other modes of operation. For example, variation manager 220 may select action handlers from action handler library 150 to invoke based on user input 230. User input 230 may, in this example, represent user input provided through a command line and may be provided to variation manager 220 instead of or in addition to instruction file 180. For example, a test engineer may type into a command line on a user interface of a computer on which test harness 200 executes. The action specified by user input 230 may be a text string similar to the text strings input into instruction file 180 by inference engine 120. Because the described system does not require that test cases be compiled, a user has significant flexibility in entering commands that cause actions to be performed during a test.

As described above in connection with FIG. 1, inference engine 120 uses state information 160 to determine the appropriate actions to take as part of a test case. In the embodiment disclosed, the test generation system may dynamically generate test cases. For dynamic generation of test cases, it may be desirable to have current state information available for inference engine 120 (FIG. 1). To provide current state information, variation manager 220 may be programmed to update state information 160 as it performs each action and observes the response. Variation manager 220 may use the observed response to update component states 162A, 162B and 162C.

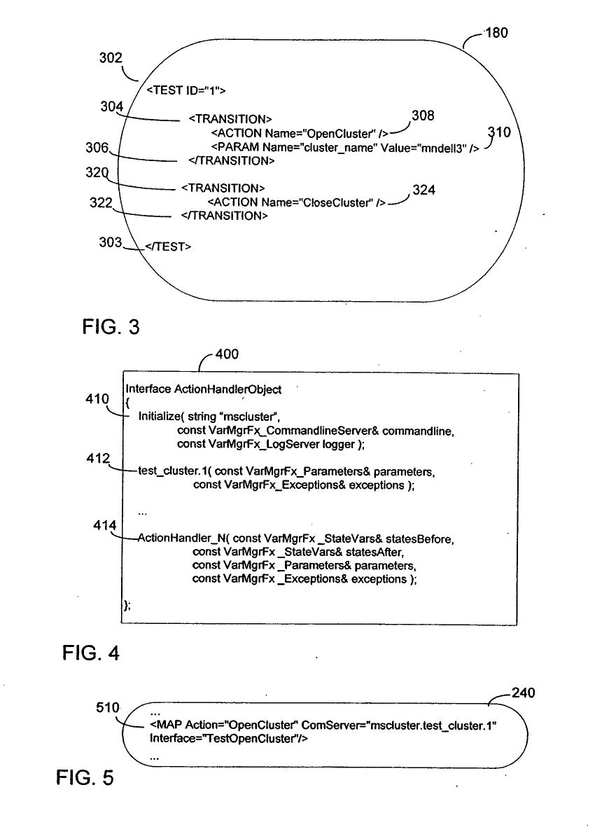

Turning to FIG. 3, details of implementation of an embodiment of the test system of FIGS. 1 and 2 are provided. FIG. 3 provides an example of a structure for instruction file 180. In this example, instruction file 180 is implemented as an XML file specifying two actions that are to be performed as part of the test case. Instruction file 180 includes tags 302 and 303 that identify the beginning and end of the test case, respectively. Tag 302 also provides an identifier for the test case.

Other tags identify the beginning and the end of each action. Here, tags 304 and 320 identify the beginning of information in the file specifying an action. Tags 306 and 322 specify the corresponding ends of the text defining actions.

Each action includes a field, such as action field 308 or 324, that is identified with an “action” tag. A string within the action field identifies the specific action to be taken.

Instruction file 180 may optionally specify one or more parameters to be used in performing each specified action. In the example of FIG. 3, the action specified between tags 304 and 306 includes a parameter field 310. Field 310 indicates that when the “OpenCluster” action is performed, the parameter “cluster_name” should be given a value of“mndell3.” In contrast, the action specified between tags 320 and 322 includes no parameter field.

FIG. 3 demonstrates that instruction file 180 need not be prepared or processed by a component in any specific programming language. Any component capable of writing text to a file or reading text from a file and parsing the text based on tags as illustrated in FIG. 3 may be used to prepare or process instruction file 180.

FIG. 4 shows an example of an interface that may be used for each of the action handlers in action handler library 150. The example of FIG. 4 illustrates an interface written in the C programming language. Instruction 410 specifies that component 400 defines a Component Object Model (COM) server and provides an identifier for the COM server as required by the COM protocol. The COM server is identified by the name “mscluster.” Multiple components in the form of component 400 may be used to define multiple COM servers.

Instructions 412 and 414 define specific action handlers that may be accessed through the COM server mscluster. In the pictured example, instruction 412 defines an action handler test_cluster.1 and instruction 414 defines an action handler identified as ActionHandler_N. Each such action handler identified in component 400 includes a body containing executable statements that define the action taken when the action handler is invoked. Additionally, each of the action handlers may include an exception handler that is invoked by variation manager 220 upon detecting a deviation between an observed value and a specified response from software under tests upon execution of the action handler. The body of the action handler and the exception handler are not expressly shown but may, for example, be coded in the C programming language using known programming techniques to define the appropriate action to be performed in executing a test case or in response to an exception.

FIG. 5 provides an example of the structure of mapper file 240. In this example, mapper file 240 is an XML file. The XML file may contain multiple fields, of which field 510 is illustrated. Field 510 identifies an action such as may be specified in instruction file 180. In field 510, the action is identified as “OpenCluster.” The field additionally includes information specifying the action handler to be invoked to perform the identified action. Field 510 identifies that the action handler may be accessed through COM server mscluster and may be invoked using the Progld name “test_cluster.1” Further information about invoking the action handler may also be specified. In this example, field 510 specifies that action handler test_cluster.1 is appropriate for use when accessing a component of software 110 through an interface identified as “TestOpenCluster.”

Mapper file 240 may contain many other fields in the form of field 510. Each field may specify a different action for which an action handler is provided. Alternatively, other fields may specify different action handlers associated with the same action when different interfaces are to be used. In one embodiment, mapper file 240 includes one field for each pair of action name and interface that may be used during execution of a test case.

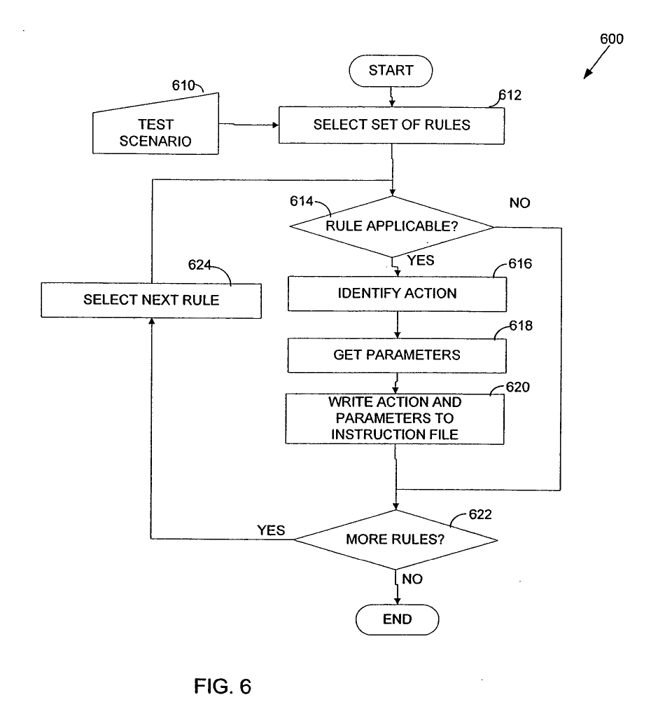

FIG. 6 shows a process by which test case generator 100 may operate. At block 610, input is provided specifying a test scenario. In the embodiment of FIG. 1, a test scenario is specified in part by user input and in part by information concerning the state of software under test. In process 600, the test scenario may be specified by input in that form or in any other suitable way.

At block 612 the information specifying a test scenario is used to select a set of rules. In the embodiment of FIG. 1, each set of rules corresponds to a specific component of the software under test. However, in the process 600, rules may be organized in any suitable way.

The process continues to decision block 614. At decision block 614, a decision is made whether the first rule in the selected set is applicable. A rule may be inapplicable because the rule specifies no action to be taken in the test scenario specified at block 610. If the rule is inapplicable, processing proceeds to decision block 622. Conversely, if the rule is applicable, processing continues to block 616. At block 616, the rule is applied to identify an action that is to be performed as part of a test case being constructed.

At block 618, parameters associated with the action identified at block 616 are gathered. FIG. 1 provides examples of sources of data for parameters to be used in executing actions. Parameters may be obtained by user input, may be generated randomly, or may be obtained from a store of parameter values.

At block 620, the action identified in block 616 along with the parameters obtained at block 618 are written into an instruction file. The action and parameters may be written in a form illustrated in FIG. 3.

Processing then proceeds to decision block 622. If it is determined at decision block 622 that the set of rules selected at block 612 contains no rules that have not been processed, process 600 ends. Conversely, if more rules remain to be processed, processing continues to block 624. At block 624, the next rule in the set is selected. The processing then loops back to decision block 614 where the selected rule is processed. In this way, the entire set of rules may be processed with actions and appropriate parameter values generated for each applicable rule.

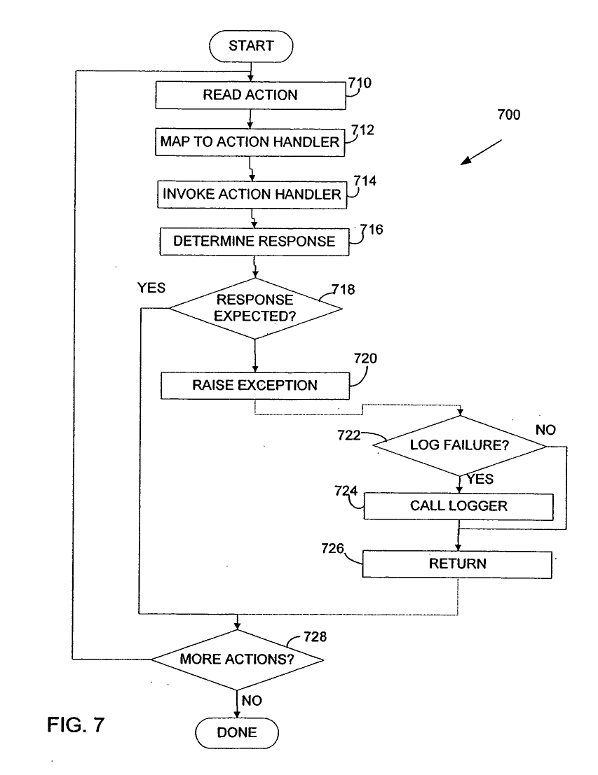

FIG. 7 illustrates a process 700 in which the test case created as a result of process 600 may be executed. At block 710, an action from the instruction file is read. In the described embodiment, actions are stored in an instruction file identified by a text string. At block 712, the identification of the action read from the instruction file is mapped to a specific action handler that defines the steps taken to execute the action. The mapping may be performed by finding an entry in a mapper file 240 or other similar data structure. An entry may be selected by matching the named action to a field within the data structure.

Once an appropriate action handler is identified, the action handler is invoked at block 714. The action handler may be invoked through a COM interface or other interface.

At block 716, a response from the software under test to the stimulus applied by invoking an action handler is determined. At decision block 718, a determination is made whether the response corresponds to an expected response. If the response is as expected, processing proceeds to decision block 728. However, if the response does not match the expected value, processing proceeds to block 720.

Process 700 includes an error sub-process that involves an exception handler within the action handler selected at block 712. To invoke the error processing sub-process, an exception is raised at block 720. Raising an exception has the effect of transferring control to the exception handler within the action handler. Steps 722, 724 and 726 are performed with exception handler.

At block 722, a determination is made whether a failure should be logged because the detected response did not match the expected response. If, as determined at decision block 722, no failure is to be logged, processing proceeds to block 726 where a return from the exception handler occurs. However, if the failure is to be logged, processing proceeds to block 724. At block 724, the failure detected because the determined response did not match the expected response is logged. In the process 700, a failure may be logged by calling a failure logging utility such as is used in test harnesses as are known in the art. Once the failure is logged at block 724, processing continues to block 726 where a return from the exception handler is performed.

The process continues at the point following the point where the exception was raised. In this example, processing resumes at decision block 728. At decision block 728, a determination is made whether additional actions remain in the instruction file. If so, processing loops back to block 710 where the next action is read. Processing continues in this fashion until all actions are specified in the instruction file are executed.

Having thus described several aspects of at least one embodiment of this invention, it is to be appreciated that various alterations, modifications, and improvements will readily occur to those skilled in the art.

As one example, test generator 100 and test framework 200 are shown separately in FIG. 1 and FIG. 2. Test generator 100 and test framework 200 may be part of one system that dynamically generates test cases in response to user input and current state information. In such a scenario, the user input may be pre-stored or entered as a test case is being prepared and executed. However, it is not necessary that the system be used to dynamically generate test cases. An instruction file 180 may be prepared and stored for use at a later time or for use at multiple later times.

Further, an embodiment was described in which a single test case was generated and executed. Embodiments are possible in which multiple test cases are generated at one time and stored in an instruction file. The process described for execution of a single test case may be repeated multiple times where multiple test cases are incorporated into a test.

Further, embodiments were described in which a single test process operates. A test system as described could be operated in one or multiple processes. If multiple processes are used, each process could perform some portion of the processing of a test case as described above. Or, each process could generate and execute a separate test case, allowing software under test to be exercised in a multiprocess environment.

As a further example, an embodiment in which a separate instruction file 180 and mapper file 240 are provided to variation manager 220. It is not necessary that separate files be used. An instruction file may include sufficient information to allow variation manager 220 to identify specific action handlers to be used.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, the invention may be embodied as a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiment.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involoving,” and variations thereof herein, is meant to encompass the items listed thereafter and equivalents thereof as well as additional items.

What is claimed is:

1. A computer-readable medium having computer-executable modules implementing a portion of a test environment for software under test with a plurality of components, the computer-executable modules comprising:
(a) a plurality of rules, each rule specifying a characteristic of a test of a component of the plurality of components in a test scenario;
(b) a plurality of action handlers, each action handler specifying at least one action to exercise a corresponding component of the plurality of components;
(c) a test case generator for receiving input specifying at least a portion of the test scenario and generating information representative of a test case for a component under test of the plurality of components, the information including a specification of at least one action that can be performed by at least one of the plurality of action handlers.

2. The computer-readable medium of claim 1, additionally comprising a module for emulating the state of the component under test.

3. The computer-readable medium of claim 1, wherein the information representative of a test case comprises an XML file.

4. The computer-readable medium of claim 1, wherein the plurality of rules are organized in a plurality of sets, each set comprising rules for testing a component of the plurality of components.

5. The computer-readable medium of claim 4, wherein the test case generator is adapted to receive user input specifying a level of testing from a set of a plurality of levels of testing.

6. The computer-readable medium of claim 5, wherein each set of rules includes rules specifying characteristics of a test to be performed for each of the plurality of levels of testing.

7. The computer-readable medium of claim 1 wherein each of the plurality of components has a plurality of interfaces and the plurality of action handlers comprises at least one action handler that specifies a sequence of steps to exercise each of the plurality of components through each of the plurality of interfaces.

8. A method of generating a test case for testing software under test having a plurality of components, comprising the acts:
(a) receiving an input specifying a test scenario;
(b) selecting based on the input at least one action that can be performed by at least one action handler in a plurality of action handlers, each action handler specifying steps that exercise a component of the plurality of components; and
(c) representing the test case as at least one action to be performed by a test framework and a mapping between the at least one action and the plurality of action handlers.

9. The method of claim 8, wherein the act (a) comprises receiving input specifying the component of the plurality of components.

10. The method of claim 9, wherein the act (a) further comprises receiving input specifying a level of testing to be performed on the component.

11. The method of claim 8, wherein the act (b) comprises determining a current state of the component under test and selecting the at least one action based at least in part on the current state.

12. The method of claim 8, further comprising the act (d) of providing the representation to a test framework as a file.

13. The method of claim 8, wherein the act (b) comprises selecting, based on the input, a set of rules and using the selected set of rules to select the at least one action.

14. A method of executing a test case against a component under test of software having a plurality of components, comprising the acts:
(a) selecting a set of rules from a plurality of sets of rules;
(b) using the selected set of rules to generate a representation of the test case, the representation comprising an indication of an action that can be performed by at least one action handler; and
(c) executing the test case by using the at least one action handler to perform the action.

15. The method of claim 14, wherein the act (c) comprises interacting with the component under test through each of a plurality of interfaces.

16. The method of claim 14, wherein each of the plurality of action handlers has a standardized interface and the act (c) comprises interacting with the action handler through the standardized interface.

17. The method of claim 16, wherein the act (c) comprises providing an exception condition to the test handler through the standardized interface.

18. The method of claim 16, wherein each of the plurality of action handlers is implemented within a COM server and the act (c) comprises interacting with the action handler through a COM interface.

19. The method of claim 14, wherein the component under test comprises a plurality of interfaces and the act (b) comprises obtaining configuration specifying which of the plurality of interfaces is to be exercised.

20. The method of claim 14, wherein the act (c) comprises providing an XML file to a test framework.
